(19) United States
(12) Patent Application Publication
(10) Pub. No.: US 2026/0081380 A1
(43) Pub. Date: Mar. 19, 2026

(54) CABLE-END CONNECTOR AND HOUSING THEREOF

(71) Applicant: Bellwether Electronic Corp., Taoyuan City (TW)

(72) Inventor: Hsing-Yu LEE, Taoyuan City (TW)

(21) Appl. No.: 19/271,810

(22) Filed: Jul. 17, 2025

Related U.S. Application Data
(60) Provisional application No. 63/694,212, filed on Sep. 13, 2024.

(51) Int. Cl. H01R 13/432; H01R 13/10; H01R 13/50; H01R 13/627

(52) U.S. Cl. CPC H01R 13/432; H01R 13/10; H01R 13/50; H01R 13/6272

(57) ABSTRACT

The present invention provides a cable-end connector which includes a housing and a terminal. The housing includes an installation channel and a guiding structure located within the installation channel. The terminal is configured to insert into the installation channel and includes two locking arms located on one side of the terminal, in which the guiding structure is configured to drive at least one of the two locking arms to elastically deform. At least one of the two locking arms is configured to elastically recover after passing the guiding structure to be fixed within the installation channel.

### CROSS-REFERENCE TO RELATED APPLICATION

This application claims priority to US Provisional Application Ser. No. 63/694,212, filed Sep. 13, 2024, which is herein incorporated by reference in its entirety.

### BACKGROUND

### Field of Invention

The present invention relates to a connector and a housing thereof. More particularly, the present invention relates to a cable-end connector and a housing thereof.

### Description of Related Art

In existing cable-end connector designs, terminals tend to detach when the cable is pulled. This makes the connector fail to perform its original function and can even lead to safety issues caused by short circuits.

To address the aforementioned problem, some connectors are equipped with a Terminal Position Assurance (TPA) mechanism to make sure that the terminals remain securely fixed inside the connector when the cable is subjected to force. However, assembling a TPA not only increases costs but also requires additional installation steps, thereby increasing the complexity of assembly.

Therefore, how to provide a cable-end connector that can be simply and stably joined to other components has become an important issue.

### SUMMARY

The present invention provides a cable-end connector including a housing and a terminal. The housing includes an installation channel and a guiding structure located within the installation channel. The terminal is configured to insert into the installation channel and includes two locking arms located on one side of the terminal, in which the guiding structure is configured to drive at least one of the two locking arms to elastically deform, and at least one of the two locking arms is configured to elastically recover after passing the guiding structure to be fixed within the installation channel.

In some embodiments of the present disclosure, the guiding structure comprises a guiding groove, and the guiding groove is configured for at least one of the two locking arms to pass through.

In some embodiments of the present disclosure, the guiding structure has an offset section, and the installation channel extends along an axial direction, and the offset section is inclined to the axial direction.

In some embodiments of the present disclosure, the two locking arms extend parallel to each other.

In some embodiments of the present disclosure, the installation channel comprises a stop portion, and the stop portion is configured to abut the at least one of the two locking arms after elastic recovery.

In some embodiments of the present disclosure, the installation channel comprises a protruding portion, and the protruding portion is configured to be clamped by the at least one of the two locking arms after elastic recovery.

In some embodiments of the present disclosure, a width of the protruding portion is smaller than a maximum interval between the two locking arms when they are elastically deformed by passing through the guiding structure.

In some embodiments of the present disclosure, the terminal further comprises a barb elastic piece, and the installation channel comprises a constricted portion, in which the barb elastic piece is configured to elastically deform when passing through the constricted portion.

In some embodiments of the present disclosure, the barb elastic piece and the two locking arms are respectively located on different sides of the terminal.

In some embodiments of the present disclosure, the housing comprises a recess, and the recess is located in the installation channel and configured to receive the barb elastic piece after it passes through the constricted portion.

In some embodiments of the present disclosure, the terminal comprises a contact portion, and the installation channel comprises a first channel portion and a second channel portion communicating with each other. A width of the second channel portion is greater than a width of the first channel portion, and the contact portion is configured to firstly pass through the first channel portion and then be accommodated in the second channel portion.

The present disclosure also provides a cable-end connector housing. The housing comprises a main body; at least one mating portion extending from a side surface of the main body; and at least one installation channel passing through the main body and the at least one mating portion. In this housing, one end of the installation channel comprises an installation opening at the main body, and another end of the installation channel comprises a mating opening at the at least one mating portion. A guiding structure and a positioning structure are provided inside the at least one installation channel, and the guiding structure has a guiding groove and an offset section. The guiding groove extends along an installation direction, and a direction of the offset section and the installation direction are not parallel to each other, and the positioning structure is connected to the offset section.

In some embodiments of the present disclosure, the positioning structure comprises a positioning surface, and a distance from a side of the positioning surface remote from the offset section to the installation opening is equal to or smaller than a distance from another side of the positioning surface proximate to the offset section to the installation opening.

In some embodiments of the present disclosure, the side surface of the main body has a window to expose the positioning surface.

In some embodiments of the present disclosure, the offset section is an inclined groove communicating with the guiding groove.

In some embodiments of the present disclosure, an angle between the inclined groove and the guiding groove is obtuse.

In some embodiments of the present disclosure, the cable-end connector housing further comprises a latch structure, connected to the main body and extending along the installation direction. In such embodiments, a width of one end of the latch structure remote from the mating portion is greater than a width of another end proximate to the mating portion.

In summary, the present disclosure, through the design of the guiding structure within the housing and corresponding locking arms on the terminal, enables the guiding structure to direct at least one locking arm to elastically deform and move outward during the insertion of the terminal into the installation channel. After passing through the guiding structure, the locking arm(s) can elastically recover, thereby securely fixing the terminal within the installation channel without the need for additional locking components or complex assembly procedures. Furthermore, if the terminal includes a barb elastic piece and the installation channel is provided with a constricted portion, the barb elastic piece will elastically deform when passing through the constricted portion during terminal insertion. Once past the constricted portion, the barb elastic piece elastically recovers and engages behind it, creating a second fixing mechanism. This further enhances the fixing strength and reliability of the terminal within the installation channel, preventing accidental disengagement.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective schematic view of a cable-end connector of the present disclosure.

FIG. 2 is a perspective schematic view of a terminal of the cable-end connector in FIG. 1.

FIG. 3 is a front schematic view of the terminal of the cable-end connector in FIG. 1 inserted into the housing.

FIG. 4 is a rear schematic view of the terminal of the cable-end connector in FIG. 1 inserted into the housing.

FIG. 5 is a cross-sectional view of the cable-end connector taken along the section line A in FIG. 1.

FIG. 6 is a cross-sectional view of cable-end connector taken along the section line A in FIG. 1, and FIG. 5 and FIG. 6 show different states of the cable-end connector, respectively.

FIG. 7 is a cross-sectional view of the cable-end connector taken along the section line B in FIG. 1.

FIG. 8 is a cross-sectional view of the cable-end connector taken along the section line C in FIG. 1.

FIG. 9 is a cross-sectional view of the cable-end connector taken along the section line C in FIG. 1, in which FIG. 8 and FIG. 9 respectively show different states.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

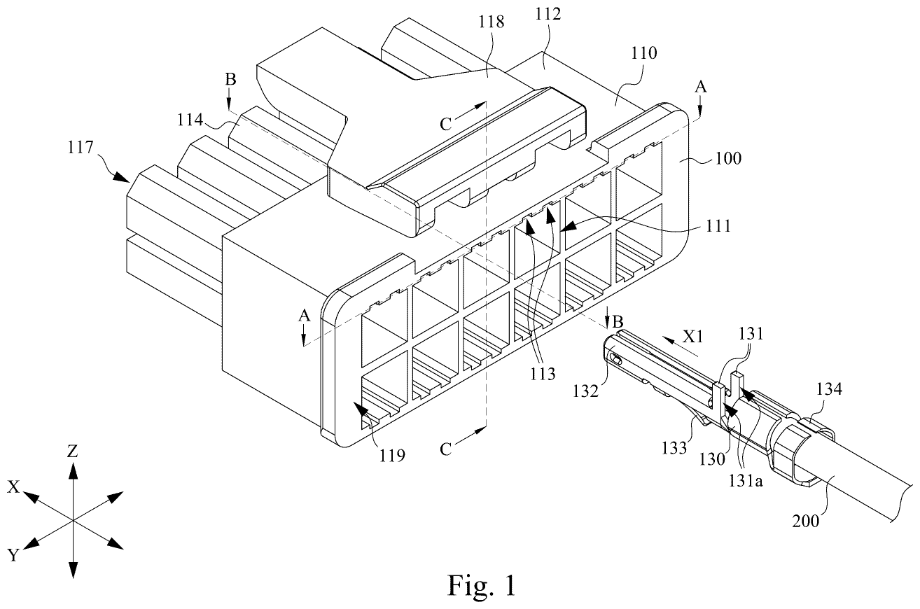

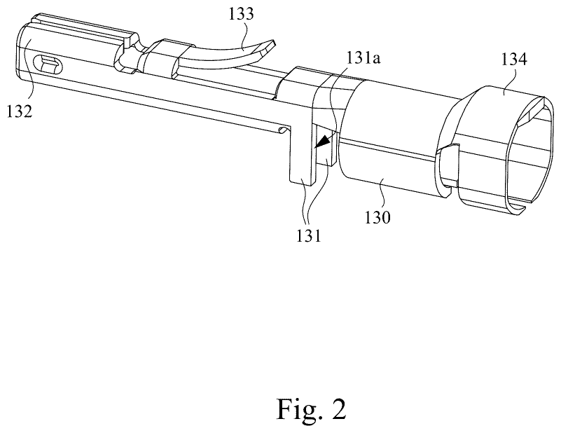

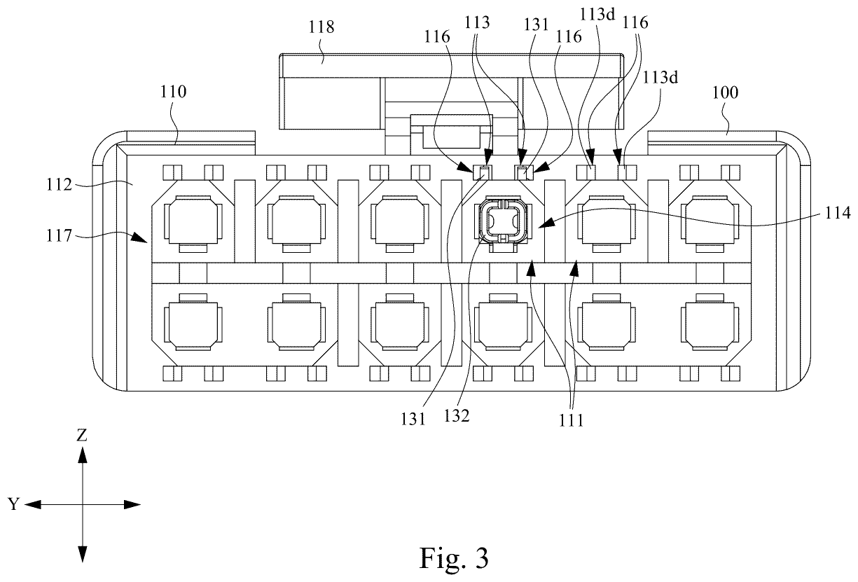

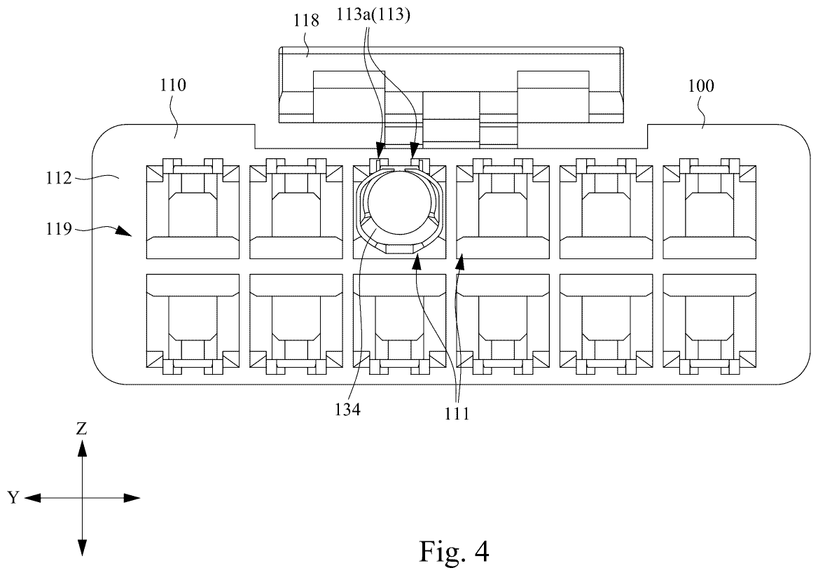

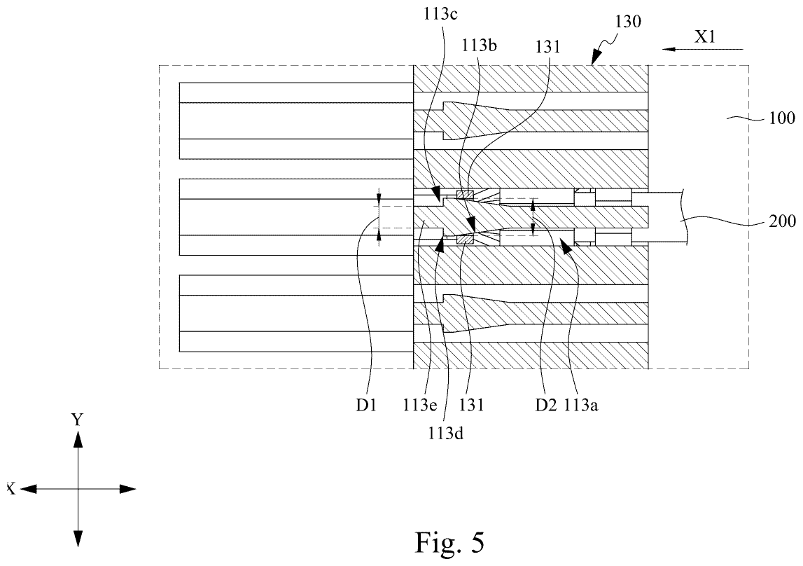

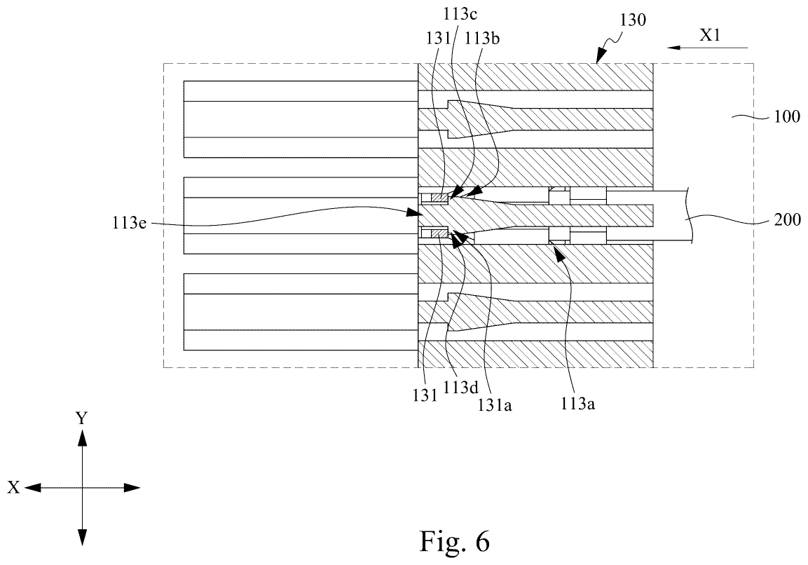

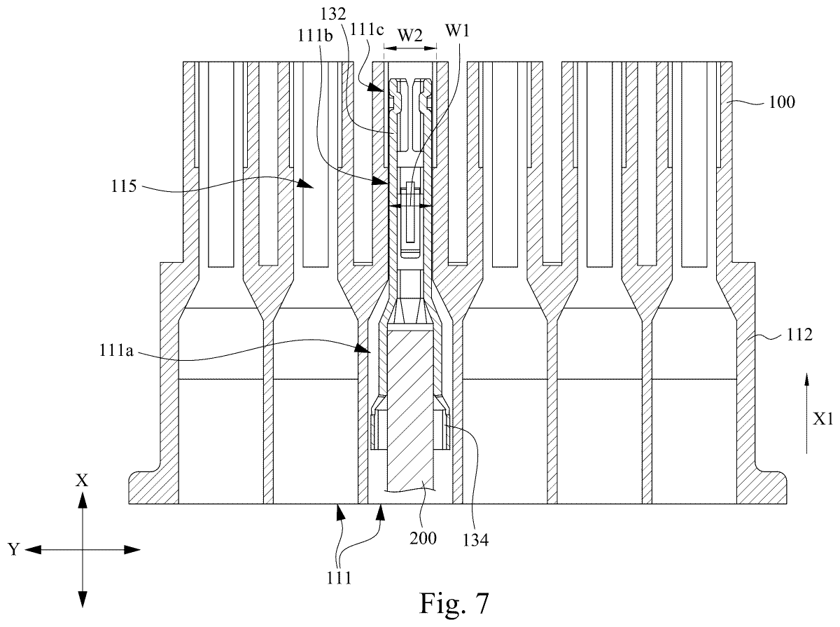

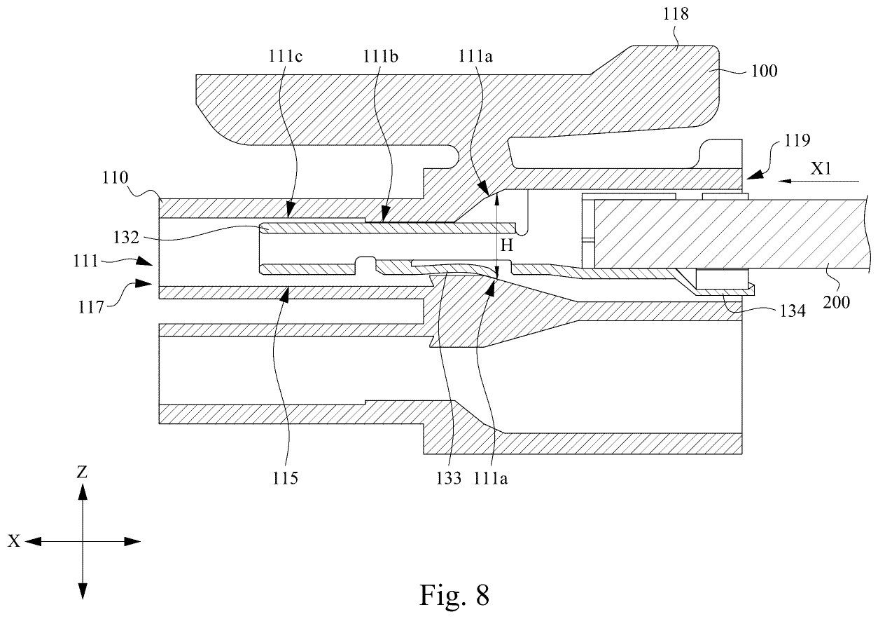

Please refer to FIG. 1 to FIG. 8 simultaneously. FIG. 1 is a perspective schematic view of a cable-end connector 100 of the present disclosure. FIG. 2 is a perspective schematic view of a terminal 130 of the cable-end connector 100 in FIG. 1. FIG. 3 is a front schematic view of the terminal 130 of the cable-end connector 100 in FIG. 1 inserted into a housing 110. FIG. 4 is a rear schematic view of the terminal 130 of the cable-end connector 100 in FIG. 1 inserted into the housing 110. FIG. 5 is a cross-sectional view of the terminal 130 of the cable-end connector 100 inserted into the housing 110, taken along the section line A in FIG. 1. FIG. 6 is a cross-sectional view of the terminal 130 of the cable-end connector 100 inserted into the housing 110, taken along the section line A in FIG. 1, and FIG. 5 and FIG. 6 show different states of the cable-end connector, respectively. FIG. 7 is a cross-sectional view of the cable-end connector 100 taken along the section line B in FIG. 1. FIG. 8 is a cross-sectional view of the cable-end connector 100 taken along the section line C in FIG. 1. The cable-end connector 100 mainly includes a housing 110 and at least one terminal 130 (the terminal 130 can be plural), and the terminal 130 can be connected to a cable 200 and assembled into the housing 110 for electrically connecting to other components. In addition, for convenience of description, an axial direction X, an axial direction Y, and an axial direction Z are defined herein, and the axial direction X, the axial direction Y, and the axial direction Z are mutually perpendicular, and serve as a basis for describing the relative positions, arrangement relationships, and force directions of components.

The housing 110 is made of an insulating material and includes at least one installation channel 111 (the installation channel 111 can be plural), and the installation channel 111 is for accommodating the terminal 130. Specifically, the installation channel 111 is an elongated channel extending along the axial direction X (first direction), and the terminal 130 can enter the housing 110 along an installation direction X1 (insertion direction). The installation direction X1 is a linear direction on the axial direction X. More specifically, the installation channel 111 passes through the housing 110 and extends from a front end to a rear end of the housing 110, thereby forming a mating opening on a front side surface 117 of the housing 110 and forming an installation opening on a rear side surface 119 of the housing 110. Inside the installation channel 111 (e.g., on its side surface or top wall), a guiding structure 113 is provided, and the guiding structure 113 is located on a path where the terminal 130 is inserted into the installation channel 111 along the installation direction X1. In this embodiment, the guiding structure 113 includes a guiding groove 113a, and the guiding groove 113a generally extends along the installation direction X1. In this embodiment, the housing 110 comprises a main body 112 and at least one mating portion 114, and the mating portion 114 is configured to be inserted into a mating connector. The mating portion 114 is a tubular structure which extends forward from one side of the main body 112. The installation channel 111 passes through the main body 112 and one mating portion 114. An installation opening of the installation channel 111 is formed on another side of the main body 112, and a mating opening of the installation channel 111 is formed at a front end of the mating portion 114. The housing 110 also has a latch structure 118 located on a top of the main body 112. The latch structure 118 is connected to the main body 112 and extends along the axial direction X, and the latch structure 118 is configured to engage with the mating connector to stabilize a mating state of the cable-end connector 100 and the mating connector. A width of a rear end of the latch structure 118 (an end remote from the mating portion 114) is greater than a width of a front end (another end proximate to the mating portion 114), for ease of user operation.

The terminal 130 is made of metal, alloy (e.g., copper alloy), or elastic alloy through stamping, cutting, or other machining processes. The terminal 130 includes locking arms 131 for engaging with the installation channel 111, a contact portion 132 located at a front side, and a cable connection portion 134 located at a rear side. The contact portion 132 is for electrically contacting additional components, and the cable connection portion 134 is for crimping a cable 200. Specifically, the locking arm 131 is an elastic body extending outward from a main body of the terminal 130, and the locking arm 131 has an abutting surface 131a. The abutting surface 131a is a side surface, located on one side of the locking arm 131 (a side proximate to the cable connection portion 134), and the abutting surface 131a is parallel to a second direction. In this embodiment, the second direction is the axial direction Z, and therefore the abutting surface 131a is perpendicular to the installation direction X1. In this embodiment, the terminal 130 has two locking arms 131 that are straight and extend along the axial direction Z, as shown in FIG. 1. Each of the locking arms 131 has two plane surfaces along the X-Z plane, and the abutting surface 131a is connected between the two plane surfaces. There is a preset distance between the two locking arms 131; such a design facilitates positioning of the terminal 130 when inserted into the installation channel 111.

Next, please refer to FIG. 5 and FIG. 6 simultaneously. FIG. 5 and FIG. 6 illustrate a process of assembling the terminal 130 into the housing 110. When the terminal 130 is pushed into the installation channel 111, the two locking arms 131 move to a position of the guiding structure 113 and advance along the guiding groove 113a. An end of the guiding structure 113 has an offset section 113b, and the offset section 113b is connected to the guiding groove 113a. Due to a guiding effect of the offset section 113b, at least one or both of the two locking arms 131 are subjected to a force causing them to deflect, causing the locking arms 131 to elastically deform, which results in the two locking arms 131 temporarily moving away from or closer to each other (e.g., expanding or constricting along the axial direction Y), such that the two locking arms 131 deform sufficiently to allow the locking arms 131 to pass over the offset section 113b. In this deformed state (a process of passing over the offset section 113b), an extension direction of the two locking arms 131 is usually no longer parallel to each other. In this embodiment, the offset section 113b is an inclined groove which communicates with the guiding groove 113a, and the inclined groove and the guiding groove 113a are not parallel to each other. For instance, an angle between the inclined groove and the guiding groove 113a (substantially equivalent to the installation direction X1) is an obtuse angle.

After the locking arms 131 pass through the offset section 113b, the locking arms 131 rapidly recover to a position close to their original state, and the two locking arms 131 are substantially parallel to each other due to their own elasticity. During or after this elastic recovery process, the two locking arms 131 move along the axial direction Y and recover to a nearly parallel state, and the two locking arms 131 engage in the installation channel 111 (please refer to FIG. 6), effectively preventing the terminal 130 from being pulled out of the housing 110 by a pulling force. Specifically, the installation channel 111 has a positioning structure 113c therein, and the two locking arms 131 that have passed over the offset section 113b engage on the positioning structure 113c. In this embodiment, the positioning structure 113c is connected to the offset section 113b, and the positioning structure 113c has a positioning surface 113d (also called a stop portion). The positioning surface 113d and the abutting surface 131a of the locking arm 131 face each other and abut each other when the terminal 130 is subjected to a pulling force, thereby counteracting the pulling force to achieve the effect of preventing the terminal 130 from detaching. The positioning surface 113d has a distal side and a proximal side. The distal side is further from the offset section 113b than the proximal side, and a distance from the distal side to the rear side surface 119 (where the installation opening is located) is substantially equal to or smaller than a distance from the proximal side to the rear side surface 119. In addition, please refer to FIG. 3, the positioning structure 113c forms a window 116 on one side surface of the housing 110 (e.g., the side surface from which the mating portion 114 extends from the main body 112) to expose the positioning surface 113d. In this embodiment, the window 116 is aligned with the positioning surface 113d in the axial direction X (installation direction X1). A user can check through the window 116 whether the locking arms 131 have reached the positioning surface 113d to confirm whether the terminal 130 is completely installed.

It should be noted that specific forms of the guiding structure 113 and the locking arms 131 can have multiple variations. For example, the guiding structure 113 can be single-sided and cause only one locking arm 131 to elastically deform. However, the guiding structure 113 can also be double-sided and cause both locking arms 131 to elastically deform. The present disclosure is not limited in this respect. In summary, the cable-end connector 100 provided by the present disclosure, through an ingenious combination of the guiding structure 113 and the locking arms 131 of the terminal 130, achieves a function of conveniently assembling the terminal 130 into the housing 110 and reliably fixing it in the housing 110.

Please refer to FIG. 5 and FIG. 6 simultaneously. In this embodiment, the offset sections 113b each include two side walls, and the two side walls gradually diverge outward along the installation direction X1. In other words, an interval between the two side walls gradually increases along the installation direction X1. When the terminal 130 is inserted into the housing 110, the two locking arms 131 respectively enter the offset sections 113b and move along surfaces of the two side walls. The two side walls drive the two locking arms 131 to elastically deform and move away from each other along the axial direction Y. During a process of the two locking arms 131 passing the two side walls and enter the positioning structure 113c, it causes the locking arms 131 to effectively elastically expand and reach a predetermined position where they can elastically recover.

Please refer to FIG. 1 to FIG. 8. In another embodiment, a protruding portion 113e can be provided inside the installation channel 111, and the protruding portion 113e is adjacent to and between the two positioning surfaces 113d. The protruding portion 113e can be a protruding rib structure extending from a bottom wall or a top wall of the installation channel 111. A position of the protruding portion 113e is usually beside a position where the two locking arms 131 pass through the guiding structure 113 and elastically recover. When one or both of the two locking arms 131 elastically recover and move towards each other along the axial direction Y, a distance between the two locking arms 131 decreases. At this time, the two locking arms 131 will be close to two sides of the protruding portion 113e or clamp the protruding portion 113e, so the two locking arms 131 respectively abut the two positioning surfaces 113d. This clamping action can not only provide additional holding force but also help to limit movement along the axial direction X or rotation along the axial direction Y of the terminal 130 within the installation channel 111, thereby increasing stability of the terminal 130 assembled in the housing 110. To ensure that the locking arms 131 can smoothly clamp the protruding portion 113e and abut the positioning surfaces 113d, a width D1 of the protruding portion 113e is approximately equal to a distance between the two positioning surfaces 113d, and the width D1 of the protruding portion 113e is smaller than an interval D2 formed between the two locking arms 131 during elastic deformation when passing through the guiding structure 113 (e.g., a maximum interval D2 reached by the two locking arms 131 during elastic deformation when passing through the offset section 113b). Therefore, after the two locking arms 131 pass over the guiding structure 113 and elastically recover, the two locking arms 131 effectively further clamp the protruding portion 113e and respectively abut the two positioning surfaces 113d, enabling the terminal 130 to be firmly locked in the housing 110.

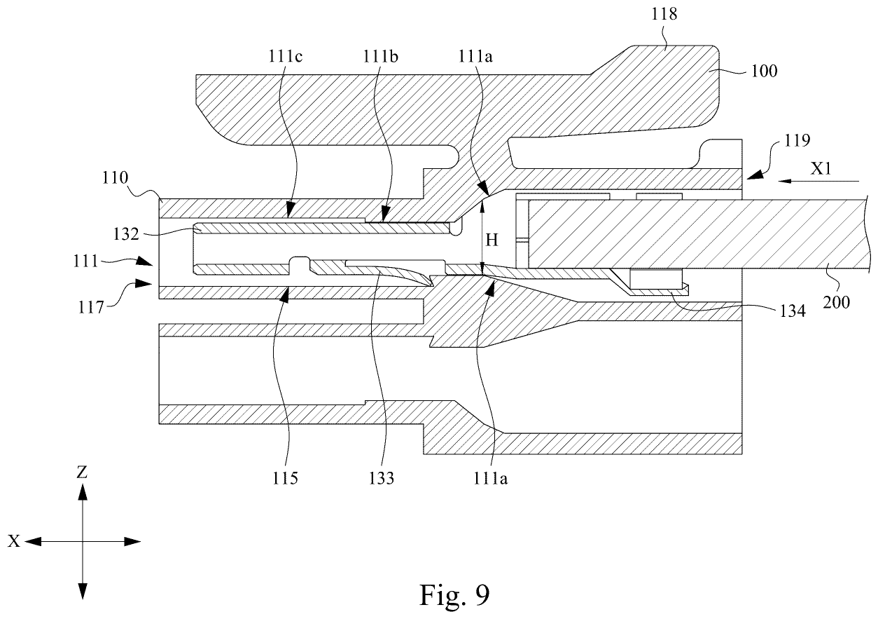

Please refer to FIG. 1 to FIG. 9. FIG. 8 is a cross-sectional view of the cable-end connector 100 taken along the section line C in FIG. 1. FIG. 9 is a cross-sectional view of the cable-end connector 100 taken along the section line C in FIG. 1, and FIG. 8 and FIG. 9 respectively show different states during installation of the terminal 130. To further enhance a retention force and stability of the terminal 130 within the housing 110, the terminal 130 may further include a barb elastic piece 133. The barb elastic piece 133 is usually an integrally formed structure formed from a metal main body of the terminal 130 through stamping or cutting processes, and the barb elastic piece 133 is a cantilever structure protruding outward and rearward from the terminal 130 and has good elasticity.

In some embodiments of the present disclosure, the two locking arms 131 and the barb elastic piece 133 are respectively located on different sides of the terminal 130. Thereby, after the two locking arms 131 and the barb elastic piece 133 elastically recover and are fixed in the installation channel 111, rotation of the terminal 130 around the axial direction Y in the installation channel 111 can be prevented. For example, the locking arms 131 may be located on a left side or a right side of the terminal 130, while the barb elastic piece 133 is located on a top side or a bottom side of the terminal 130. The present disclosure is not limited in this respect. In a specific embodiment of the present disclosure, the two locking arms 131 and the barb elastic piece 133 are respectively located on opposite sides of the terminal 130, e.g., the locking arms 131 are located on a top side of the terminal 130 and the barb elastic piece 133 is located on a bottom side of the terminal 130, thereby enhancing stability of the terminal 130 fixed in the housing 110.

In some embodiments of the present disclosure, the installation channel 111 includes a constricted portion 111a to cooperate with the barb elastic piece 133 on the terminal 130 to achieve a locking function. The constricted portion 111a is located on a path where the terminal 130 is inserted into the installation channel 111 and is used to abut the barb elastic piece 133. Specifically, the constricted portion 111a includes a height H that gradually decreases along the installation direction X1, thereby facilitating guiding the barb elastic piece 133 to elastically compress along the axial direction Z in the installation channel 111. In practical application, when the terminal 130 is inserted into the installation channel 111, the barb elastic piece 133 contacts the constricted portion 111a. Due to a spatial limitation of the constricted portion 111a, the barb elastic piece 133 is subjected to pressure and elastically deforms along the axial direction Z. When the barb elastic piece 133 passes over the constricted portion 111a, the barb elastic piece 133 utilizes its own elasticity to rapidly recover, so as to be further fixed in the installation channel 111. Specifically, the constricted portion 111a may include one or more inclined surfaces or curved surfaces inclined to the installation direction X1, thereby achieving an effect of gradually elastically compressing the barb elastic piece 133 when the terminal 130 is moving along the installation direction X1.

In addition, the installation channel 111 further includes a recess 115 provided on its inner wall. The recess 115 is for accommodating the barb elastic piece 133 after the barb elastic piece 133 passes through the constricted portion 111a and elastically recovers, and the recess 115 is recessed along the axial direction Z in the inner wall of the installation channel 111 and is used to limit the barb elastic piece 133 in the axial direction X, thereby preventing the terminal 130 from moving rearward along the axial direction X or rotating around the axial direction X. Therefore, the design of the barb elastic piece 133 and the recess 115 can provide additional locking force and enhance connection reliability between the housing 110 and the terminal 130.

Please refer to FIG. 1 to FIG. 9 (especially FIG. 7). The installation channel 111 further includes a first channel portion 111b and a second channel portion 111c communicating with the constricted portion 111a, and the first channel portion 111b communicates between the constricted portion 111a and the second channel portion 111c. In addition, the first channel portion 111b and the second channel portion 111c are configured for a contact portion 132 of the terminal 130 to pass through and be accommodated, and a width W1 of the first channel portion 111b is substantially the same as a width of the contact portion 132, and a width W2 of the second channel portion 111c is greater than the width W1 of the first channel portion 111b. Since the width W1 of the first channel portion 111b is slightly greater than or substantially equal to the width of the contact portion 132, when the contact portion 132 is inserted into the first channel portion 111b, the first channel portion 111b can provide preliminary guiding and alignment for the contact portion 132, ensuring that the contact portion 132 is further correctly inserted into the second channel portion 111c along the installation direction X1. As the terminal 130 continues to advance until the contact portion 132 enters the wider second channel portion 111c, the second channel portion 111c provides additional mating space for the contact portion 132, enabling the contact portion 132 to freely, smoothly and reliably mate with another component. In summary, the contact portion 132 is configured to firstly pass through the first channel portion 111b, and then enter and be accommodated in the second channel portion 111c. This narrow-then-wide channel design, combined with an action of the constricted portion 111a, not only helps in precise alignment of the terminal 130 during insertion but also provides sufficient space and flexibility for mating of the contact portion 132, ensuring connection reliability.

In summary, the cable-end connector 100 of the present disclosure, through an ingenious design of the elastic locking arms 131 and the barb elastic piece 133 of the terminal 130 and via interaction with a structure of the housing 110, achieves rapid, simple, and stable fixing of the terminal 130 in the housing 110, so as to avoid additional parts and redundant steps that may be required by traditional connectors. In some embodiments, this design further enhances connection reliability, thereby ensuring the terminal 130 remains securely fastened. Therefore, the locking arms 131 and the barb elastic piece 133 can form two fixing mechanisms, further improving a fixing strength and reliability of the terminal 130 within the installation channel 111, and preventing the terminal 130 from accidentally loosening from the housing 110.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A cable-end connector, comprising:
a housing including an installation channel and a guiding structure located within the installation channel; and
a terminal configured to be inserted into the installation channel and including two locking arms located on one side of the terminal, wherein the guiding structure is configured to guide at least one of the two locking arms to elastically deform, the at least one of the two locking arms is configured to elastically recover after passing through the guiding structure to be fixed in the installation channel.

2. The cable-end connector of claim 1, wherein the guiding structure comprises a guiding groove which is configured for at least one of the two locking arms to pass through.

3. The cable-end connector of claim 1, wherein the guiding structure has an offset section, the installation channel extends along an axial direction, and the offset section is inclined to the axial direction.

4. The cable-end connector of claim 1, wherein the two locking arms extend parallel to each other.

5. The cable-end connector of claim 1, wherein the installation channel comprises a stop portion which is configured to abut the at least one of the two locking arms after elastic recovery.

6. The cable-end connector of claim 1, wherein the installation channel comprises a protruding portion configured to be clamped by the at least one of the two locking arms after elastic recovery.

7. The cable-end connector of claim 6, wherein a width of the protruding portion is smaller than a maximum interval between the two locking arms when elastically deformed by passing through the guiding structure.

8. The cable-end connector of claim 1, wherein the terminal further comprises a barb elastic piece, the installation channel comprises a constricted portion, wherein the barb elastic piece is configured to elastically deform when passing through the constricted portion.

9. The cable-end connector of claim 8, wherein the barb elastic piece and the two locking arms are respectively located on different sides of the terminal.

10. The cable-end connector of claim 8, wherein the housing comprises a recess disposed in the installation channel and configured to receive the barb elastic piece after it passes through the constricted portion.

11. The cable-end connector of claim 1, wherein the terminal comprises a contact portion, the installation channel comprises a first channel portion and a second channel portion communicating with each other, and a width of the second channel portion is greater than a width of the first channel portion, the contact portion is configured to firstly pass through the first channel portion and then be accommodated in the second channel portion.

12. A cable-end connector housing, comprising:
a main body;
at least one mating portion, extending from a side surface of the main body;
and at least one installation channel passing through the main body and the at least one mating portion, wherein one end of the installation channel comprises an installation opening at the main body, another end of the installation channel comprises a mating opening at the at least one mating portion, wherein a guiding structure and a positioning structure are provided inside the at least one installation channel, the guiding structure has a guiding groove and an offset section, and the guiding groove extends along an installation direction, a direction of the offset section and the installation direction are not parallel to each other, and the positioning structure is connected to the offset section.

13. The cable-end connector housing of claim 12, wherein the positioning structure comprises a positioning surface, a distance from a side of the positioning surface remote from the offset section to the installation opening is equal to or smaller than a distance from another side of the positioning surface proximate to the offset section to the installation opening.

14. The cable-end connector housing of claim 13, wherein the side surface of the main body has a window to expose the positioning surface.

15. The cable-end connector housing of claim 12, wherein the offset section is an inclined groove communicating with the guiding groove.

16. The cable-end connector housing of claim 15, wherein an angle between the inclined groove and the guiding groove is obtuse.

17. The cable-end connector housing of claim 12, further comprising a latch structure connected to the main body and extending along the installation direction, wherein a width of one end of the latch structure remote from the mating portion is greater than a width of another end proximate to the mating portion.
